(19) United States
(12) Patent Application Publication
(10) Pub. No.: US 2013/0327066 A1
(43) Pub. Date: Dec. 12, 2013

(54) TEMPERATURE CONTROL

(71) Applicants: Arne Barrett Sele, Hosle (NO); Trygve Johannes Lund, Oslo (NO)

(72) Inventors: Arne Barrett Sele, Hosle (NO); Trygve Johannes Lund, Oslo (NO)

(73) Assignee: AKER ENGINEERING & TECHNOLOGY AS, Lysaker (NO)

(21) Appl. No.: 14/001,054

(22) PCT Filed: Feb. 24, 2012
(86) PCT No.: PCT/NO2012/050030

§ 371 Date: Aug. 22, 2013

(30) Foreign Application Priority Data
Feb. 24, 2011 (NO) 20110305

(51) Int. Cl. F17C 9/02

(52) U.S. Cl. CPC F17C 9/02
USPC 62/50.1; 222/1; 222/146.2

(57) ABSTRACT

The present invention provides a method for increasing the internal pressure of a pressure vessel (1) containing a medium being present in both a liquid (3) and gaseous (2) phase, the vessel comprising one inner (9)and one outer (10) fluid tight barrier, said barriers being separated by an inter-barrier space (8), comprising the steps of: —circulating a suitable fluid through both the inter-barrier space and a heating unit; and —heating the fluid by the heating unit.

### TECHNICAL FIELD

The present invention relates to tanks for storage and transportation of fluids such as hydrocarbons, including low temperature liquefied natural gas. This includes tanks for storage and transportation including mobile and fixed fuel tanks for marine and onshore applications.

### BACKGROUND OF THE INVENTION

For a number of applications liquefied gas may be conveniently stored in pressure vessels. One advantage is that in such tanks the evaporating liquid may be retained until a convenient time when the gas phase is required for consumption. For use in combustion engines it is in particular required that hydrocarbon gas needs to be delivered at controlled pressure. Another aspect is that from a tank under sufficient pressure liquid can be drained above the level of the stored liquefied gas without the use of a pump. This allows the liquid to be drained from the tank without allowing apertures below the liquid surface from which the liquid may be drained by gravity. This provides safety against accidental uncontrolled leakage in the event of valve failure to close. Leakage of liquid with low temperature will due to its large heat capacity almost immediately cause brittle fracture of conventional shipbuilding and structural materials. Under such an accidental condition pressure may immediately be bled off by a valve releasing the pressure on the gas if there is no outlet below the liquid level.

The limitation of this technique is that sufficient pressure needs to be maintained in the tank to overcome the hydrostatic head at the top of the tank. Current practice is to drain liquid from a small aperture at the bottom of the tank into a heat exchanger where this is evaporated and fed into the gas phase in the tank increasing the vapour pressure. This is done at the expense of the accidental occurrence that cryogenic liquid may leak and cause brittle fracture. The liquid phase may then be piped out of the tank above the liquid phase level inside the tank.

### OBJECT OF THE INVENTION

The object of the current invention is to provide a novel method for increasing the pressure in a pressure vessel containing liquefied gas, which minimizes or alleviates at least some of the disadvantages of the prior art techniques, especially the risk of accidental leakage of cryogenic liquid.

### SUMMARY OF THE INVENTION

In this invention a tank, or pressure vessel, consisting of two liquid tight barriers is utilised. The two barriers may advantageously be formed by the use of sandwich panels comprising two opposing plates connected by at least one web. By constructing a pressure vessel from such panels, a vessel having two liquid tight barriers, the barriers separated by an inter-barrier space, is obtained. A heating unit, preferably a heat exchanger, is mounted in fluid contact with the inter-barrier space. If the heating unit is a heat exchanger, a suitable heating medium such as air or water is circulated through one side of said heat exchanger. On the opposite side of the heat exchanger a suitable fluid such as nitrogen may be circulated through said heat exchanger and the inter-barrier space of the tank in a closed circuit. Circulation of said fluid may be achieved by convection alone, or by a suitable impeller such as a fan. When only convection is utilized for circulating the fluid, it is important that the intake/return pipes are placed correctly on the pressure vessel. It is preferred that the pipe providing heated fluid from the heat exchanger is situated above the liquid level of the tank, and the pipe providing cooled fluid to the heat exchanger being situated below said liquid level. Adequate separation of the two pipes is necessary in order to obtain a proper circulation in the inter-barrier space. The double barrier tank wall acts as a second heat exchanger increasing the thermal energy of the contained fluids causing boil-off and increased pressure in the tank. The increased pressure is achieved without penetrating the tank below the liquid level in the tank and without requiring the use of a pump. The heat exchanger, heating the medium circulating through the inter-barrier space of the tank may be replaced by any other suitable heating unit known to a person skilled in the art. The present invention is further defined in the following, providing:

A method for increasing the internal pressure of a pressure vessel containing a medium being present in both a liquid and gaseous phase, the vessel comprising one inner and one outer fluid tight barrier, said barriers being separated by an inter-barrier space, comprising the steps of:
circulating a suitable fluid through both the space and a heating unit; and
heating the fluid by the heating unit.

In one embodiment of the method according to the invention, the heating unit is a heat exchanger, but other types of heating units using for instance electricity, combustion or solar energy to provide the required heating, may also be used.

In a further embodiment of the method according to the invention, a suitable heating medium, such as water or air, is provided to the heat exchanger on the opposite side of the fluid from the inter-barrier space.

The invention also provides a pressure vessel for a medium having both a liquid and a gaseous phase, comprising one outer and one inner fluid tight barrier, the two barriers being separated by an inter-barrier space, the pressure vessel may advantageously be constructed as described above, wherein the space between the two barriers is connected to a heating unit by pipes, such that a fluid may be circulated through both the barrier space and the heating unit, said heating unit heating the fluid.

In one embodiment of the pressure vessel according to the invention, the fluid is a suitable gas, such as nitrogen.

In another embodiment of the pressure vessel according to the invention, the fluid is a suitable liquid, such as methanol.

The type and nature of the fluid being used to circulate in the inter-barrier space is dependent on the properties, e.g. condensation temperature, of the fluid being contained by the pressure vessel. In the case of a pressure vessel containing LNG, a suitable circulating fluid will for example be nitrogen. In the case of a pressure vessel containing LPG, a suitable circulating fluid will in addition to nitrogen also be, for example, a suitable liquid such as methanol.

In yet another embodiment of the pressure vessel according to the invention, the heating unit is a heat exchanger.

In yet another embodiment of the pressure vessel according to the invention, water or air is used as the heat source for the heat exchanger.

In another embodiment of the pressure vessel according to the invention, the vessel comprises a pipe having two ends, one end of the pipe being internal to the vessel and situated below the level of the liquid phase. The other end of the pipe is situated external to the tank, providing a means for transferring liquid out of the tank.

In another embodiment of the pressure vessel according to the invention, said vessel comprises an impeller, preferably a fan, for circulating the fluid through both the heating unit and the inter-barrier space.

### BRIEF DESCRIPTION OF THE DRAWINGS

FIG. 1 shows a schematic drawing of the invention.

### DETAILED DESCRIPTION

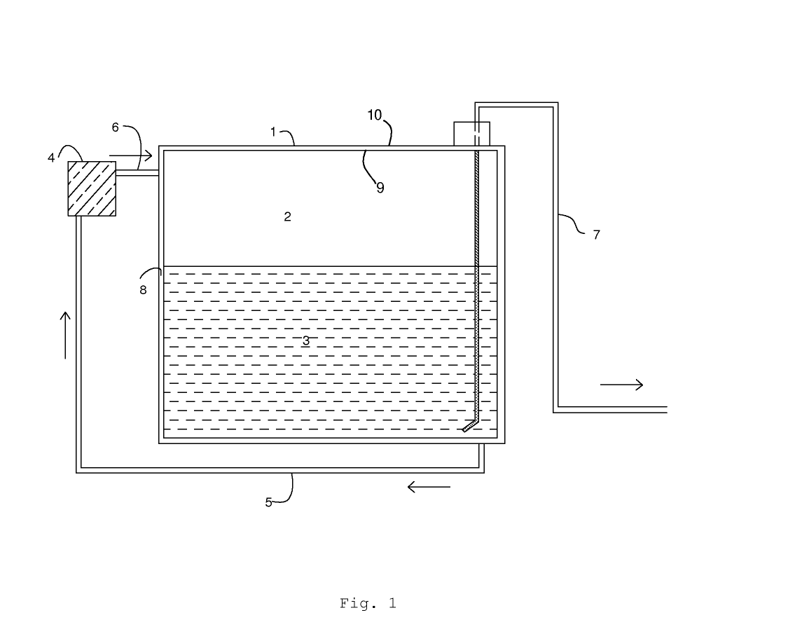

FIG. 1 shows a double barrier (inner 9 and outer 10 barrier walls) pressure vessel 1 containing the gas phase of the stored medium 2 and the liquid phase 3. The external heating unit 4 (in this case intended to be a heat exchanger) heats a fluid which circulates through a pipe 6 into the inter-barrier space 8 through a return pipe 5 and back into the heat exchanger 4. The increased evaporation from the liquid 3, due to the heat provided by the circulating fluid, causes increased pressure in the gas phase 2. This in turn provides sufficient pressure to overcome the hydrostatic head required to expel the stored liquid 3 through the pipe 7.

1. A method for increasing the internal pressure of a pressure vessel containing a medium being present in both a liquid and gaseous phase by heating at least part of the medium in the pressure vessel for expelling the liquid phase out over the top of the vessel, the vessel comprising one inner and one outer fluid tight barrier, said barriers being separated by an inter-barrier space, wherein the method comprises
circulating a suitable fluid other than said medium through both the inter-barrier space and a heating unit in a closed loop; and
heating the fluid by the heating unit.

2. A method according to claim 1, wherein the heating unit is a heat exchanger.

3. A method according to claim 2, wherein a suitable heating medium, such as water or air, is provided to the heat exchanger on the opposite side of the fluid from the inter-barrier space.

4. A pressure vessel for a medium having both a liquid and a gaseous phase, comprising one inner and one outer fluid tight barrier, the two barriers being separated by an inter-barrier space, and means for heating at least part of the medium to be stored in the pressure vessel in order to increase the pressure in the vessel for expelling the liquid phase out over the top of the vessel wherein the space between the two barriers is connected to a heating unit by pipes, such that a fluid other than said medium may be circulated through both the barrier space and the heating unit in a closed loop, said heating unit being arranged to heat the fluid.

5. A pressure vessel according to claim 4, wherein the fluid is a suitable gas, such as nitrogen.

6. A pressure vessel according to claim 4, wherein the fluid is a suitable liquid, such as methanol.

7. A pressure vessel according to claim 4, wherein the heating unit is a heat exchanger.

8. A pressure vessel according to claim 7, wherein water or air is circulated through the heat exchanger to heat the fluid.

9. A pressure vessel according to claim 4, wherein the vessel comprises a pipe having two ends, one end of the pipe being internal to the pressure vessel and situated below the level of the liquid phase.

10. A pressure vessel according to claim 4, comprising an impeller, preferably a fan, for circulating the fluid.
